(19) United States
(12) Patent Application Publication
(10) Pub. No.: US 2006/0041089 A1
(43) Pub. Date: Feb. 23, 2006

(54) Castable shape memory polymers

(76) Inventors: Patrick T. Mather, Storrs, CT (US); Changdeng Liu, Storrs, CT (US)

Correspondence Address: CANTOR COLBURN, LLP, 55 GRIFFIN ROAD SOUTH, BLOOMFIELD, CT, 06002, US

(21) Appl. No.: 10/965,917

(22) Filed: Oct. 15, 2004

Related U.S. Application Data
(63) Continuation of application No. 10/425,451, filed on Apr. 29, 2003.
(60) Provisional application No. 60/377,544, filed on May 2, 2002.

(51) Int. Cl. C08F 4/06

(52) U.S. Cl. 526/147; 526/347.1; 526/334; 526/210; 526/206; 526/207; 526/212; 526/219; 526/229; 526/336; 526/347

(57) ABSTRACT

Shape memory polymers prepared by copolymerizing two monomers, which each separately produce polymers characterized by different glass transition temperatures in the presence of a difunctional monomer whereby the copolymer formed is cross-linked during the polymerization to form a theremoset network. The transition temperature of the final polymers is adjusted by the ratio of the monomers selected, to from about 20 to about 110° C., while the degree of cross-linking controls the rubbery modulus plateau. The shape memory polymers can be processed as castable formulations in the form of coatings and films. The copolymers are optically transparent and are useful as medical plastics. The invention also relates to the articles of manufacture thereof and methods of the preparation and use thereof.

### CROSS-REFERENCE TO RELATED APPLICATION

This application is a continuation of U.S. application Ser. No. 10/425,451, filed on Apr. 29, 2003, which is incorporated herein in its entirety.

### FIELD OF THE INVENTION

This invention relates to shape memory polymers and their production. More particularly it relates to shape memory copolymers which comprise a reaction product of two vinyl monomers which if they had been separately polymerized would produce polymers characterized by different glass transition temperatures, and a difunctional monomer whereby the copolymer formed is crosslinked during the polymerization to form a thermoset network. The transition temperatures of the final polymers are adjusted by the ratio of the monomers selected to from 20-110° C., while the degree of crosslinking controls the rubbery modulus plateau. The shape memory polymers are castable, are optically transparent and can be dyed to any color as dictated by their intended application.

### BACKGROUND OF THE INVENTION

Shape memory materials are those materials that can be “fixed” to a temporary and dormant shape under specific conditions of temperature and stress and later, under thermal, electrical, or environmental command, the associated elastic deformation can be substantially completely relaxed to the original, stress-free, condition.

The primary class of shape memory materials studied and utilized are the shape memory alloys (SMA). The shape-memory capabilities of the various metallic materials (shape memory alloys) capable of exhibiting shape-memory characteristics occur as the result of the metallic alloy undergoing a reversible crystalline phase transformation from one crystalline state to another crystalline state with a change in temperature and/or external stress. In particular, alloys of nickel and titanium for example, nitanol exhibit these properties of being able to undergo energetic crystalline phase changes at ambient temperatures, thus giving them a shape-memory. Such alloys have shape memory effects that exploit the deformation-behavior difference between a high temperature austenite phase (parent phase) and the room temperature martensite phase, a first-order phase transition separating the two phases. As the “yield stress” of martensite is extremely low, the matensitic structure is very easily deformed due to the twinning of the crystalline grains, but this yielded deformation is quite reversible. The deformed martensitic sample maintains its form until it is heated above the critical temperature associated with transformation to the austenitic phase. At that point, structural recovery occurs to achieve the original shape that existed before martensitic deformation.

This transformation is often referred to as a thermoelastic martensitic transformation. The reversible transformation of the NiTi alloy between the austenite to the martensite phases occurs over two different temperature ranges which are characteristic of the specific alloy. As the alloy cools, it reaches a temperature (Mₛ) at which the martensite phase starts to form, and finishes the transformation at a still lower temperature (M_{f}). Upon reheating, it reaches a temperature (Aₛ) at which austenite begins to reform and then a temperature (A_{f}) at which the change back to austenite is complete. In the martensitic state, the alloy can be easily deformed. When sufficient heat is applied to the deformed alloy, it reverts back to the austenitic state, and returns to its original configuration.

As afore-noted, the most well known and most readily available shape-memory alloy is an alloy of nickel and titanium. With a temperature change of as little as about 10° C., this alloy can exert a stress as large as 415 MPa when applied against a resistance to changing its shape from its deformed state. Such alloys have been used for such applications as intelligent materials and biomedical devices. Their use, however has been limited in part because they are relatively expensive, but also due to limited strain, ca. 8%.

Shape memory polymers (SMPs) are being developed to replace or augment the use of shape memory metal alloys (SMAs), in part because the polymers are light in weight, high in shape recovery ability, easy to manipulate and because they are economical as compared with SMAs.

Polymers intrinsically show shape memory effects on the basis of rubber elasticity, but with varied characteristics of temporary shape fixing, strain recovery rate, work capability during recovery, and retracted state stability. The first shape memory polymer (SMP) reported as such was cross-linked polyethylene; however, the mechanism of strain recovery for this material was immediately identified as far different from that of the shape memory alloys. Indeed, a shape memory polymer is actually a super-elastic rubber: when the polymer is heated to a rubbery state, it can be deformed under resistance of ˜1 MPa modulus, and when the temperature is decreased below either a crystallization temperature or glass transition temperature, the deformed shape is fixed by the lower temperature rigidity while, at the same time, the mechanical energy expended on the material during deformation will be stored. Thus, when the temperature is raised above the transition temperature (T_{g} or Tₘ), the polymer will recover to its original form as driven by the restoration of network chain conformational entropy. Thus, favorable properties for SMPs will be closely linked to the network architecture and to the sharpness of the transition separating the rigid and rubber states. Compared with SMAs, SMPs have an advantage of high strain (to several hundred percent) because of the large rubbery compliance while the maximum strain of the SMA is less than 8%. As an additional advantage, the transition temperature can be tailored according to the application requirements, a factor that is very important in industry.

Heretofore, numerous polymers have been found to have particularly attractive shape memory effect, most notably the polyurethanes, polynorbornene, styrene-butadiene copolymers, and cross-linked polyethylene. However the processing of these polymers has given rise to numerous difficulties.

In the literature, polyurethane-type SMPs have generally been characterized as phase segregated linear block co-polymers having a hard segment and a soft segment. The hard segment is typically crystalline, with a defined melting point, and the soft segment is typically amorphous, with a defined glass transition temperature. In some embodiments, however, the hard segment is amorphous and has a glass transition temperature rather than a melting point. In other embodiments, the soft segment is crystalline and has a melting point rather than a glass transition temperature. The melting point or glass transition temperature of the soft segment is substantially less than the melting point or glass transition temperature of the hard segment.

In actual production when the SMP is heated above the melting point or glass transition temperature of the hard segment, the material can be shaped. This (original) shape can be memorized by cooling the SMP below the melting point or glass transition temperature of the hard segment. When the shaped SMP is cooled below the melting point or glass transition temperature of the soft segment while the shape is deformed, a new (temporary) shape is fixed. The original shape is recovered by heating the material above the melting point or glass transition temperature of the soft segment but below the melting point or glass transition temperature of the hard segment. In another method for setting a temporary shape, the material is deformed at a temperature lower than the melting point or glass transition temperature of the soft segment, resulting in stress and strain being absorbed by the soft segment. When the material is heated above the melting point or glass transition temperature of the soft segment, but below the melting point (or glass transition temperature) of the hard segment, the stresses and strains are relieved and the material returns to its original shape.

It has been proposed to provide SMP materials by combining two polymers, one a so-called hard segment and the other a soft segment. The melting point or glass transition temperature (hereinafter Tₜᵣₐₙₛ) of the hard segment is at least 10° C. and preferably 20° C. higher than the Tₜᵣₐₙₛ of the soft segment. Polymers that are crystalline or amorphous and that have a Tₜᵣₐₙₛ within the range have been used to form the hard and soft segments. The Tₜᵣₐₙₛ of the hard segment is preferably between −30 and 270° C., and more preferably between 30 and 150° C. The ratio by weight of the hard segment:soft segments is between about 5:95 and 95:5 preferably between 20:80 and 80:20. The shape memory polymers can also contain at least one physical crosslink (physical interaction of the hard segment) or contain covalent crosslinks instead of a hard segment. The shape memory polymers also can be interpenetrating networks or semi-interpenetrating networks.

Examples of polymers used to prepare hard and soft segments of known SMPs include various polyethers, polyacrylates, polyamides, polysiloxanes, polyurethanes, polyethers, polyether amides, polyurethane/ureas, polyether esters, and urethane/butadiene copolymers. See for example, U.S. Pat. No. 5,506,300 to Ward et al.; U.S. Pat. No. 5,145,935 to Hayashi;

U.S. Pat. No. 5,665,822 to Bitler et al.; and Gorden, “Applications of Shape Memory Polyurethanes,” Proceedings of the First International Conference on Shape Memory and Superelastic Technologies, SMST International Committee, pp. 115-19 (1994).

It has also been proposed to use highly crosslinked homopolymers with Tg>room temperature and long-lived the entanglements serving as crosslinks. However, the use of entanglements as the sole origin of elasticity leads to significant difficulties in the processing thus leading to the required use of plasticizers that ultimately hamper shape memory performance. Existing shape memory polymers have been prepared on the basis of polyurethane (Mitsubishi), and Norsorex™ (Nippon Zeon) and used as a rubber. Neither can be cast to complex shapes without the use of solvents and neither is sufficiently optically clear to be used in optical applications. The aforesaid severe limitations emphasizes the need for castable, reactive formulations, in which the stress-free state is formed during the polymerization process itself. In such a case, shape memory castings (solid objects), films, coatings, and adhesives could all be processed from the same formulation but altered processing schemes.

It is an object of the present invention to provide shape memory polymers that are able to form objects which can hold shape in memory in which the transition temperature and the rubbery modulus can be tailored according to the intended application.

Another object of the invention is to provide polymers that are able to form objects which can hold shape in memory in which the transition temperature and the rubbery modulus can be tailored according to the intended application and the recoverable strain can exceed several hundred percent.

It is a further object of the present invention to provide shape memory polymers with physical and chemical structures that are different from those in the known shape memory polymers.

It is still a further object of the invention to provide shape memory polymers that can be processed as castable formulations in the form of coatings, films and adhesives.

Yet another affect of the invention is to provide optically transparent and colorless castable shape memory polymers.

### SUMMARY OF THE INVENTION

In accordance with the invention, the above objects are realized and the disadvantages of the prior art shape memory products, for example of the shape memory alloys and polyurethanes, avoided by copolymerizing two monomers each selected from the categories of vinyl monomers, vinylidene monomers, and alkyl methacrylates to form castable shape memory polymers (CSMP) with quite different glass transition temperatures than that associated with either of their homopolymers and incorporating a multifunctional monomer into the polymerization reaction so that the copolymer is crosslinked during polymerization to form a thermoset network.

In addition to the two monomers selected from vinyl, vinylidene and alkyl methacrylate monomers and the multifunctional cross-linking agent, an initiator such as an organic peroxide or an azo compound is present.

The invention includes the use of a mixture of two or more monomers, plus a crosslinking agent, with at least one selected monomer being from each of the categories, high-T_{g} polymer-forming and low-T_{g} polymer-forming.

High-T_{g} polymer-forming monomers include the following: vinyl chloride, vinyl butyral, vinyl fluoride, vinyl pivalate, 2-vinylnaphthalene, 2-vinylpyridine, 4-vinyl pyridine, vinylpyrrolidone, n-vinyl carbazole, vinyl toluene, vinyl benzene (styrene), methyl methacrylate, ethyl methacrylate, acryl-functionalized POSS, and methacryl-functionalized POSS, among others. (POSS refers to the polyhedraloligosilsesquioxane commercially available from Hybrid Plastics, Inc.).

Low-Tg polymer-forming monomers include: vinyl ethyl ether, vinyl laurate, vinyl methyl ether, vinyl propionate, alkyl acrylates (methyl acrylate, ethyl acrylate, propyl acrylate, butyl acrylate), and alkyl methacrylates (propyl methacrylate, butyl methacrylate).

The monomers must be purified for removal of inhibitor either by distillation or flow through a column designed for this purpose prior to use.

The multifunctional monomer or crosslinking agents include diacrylates: propoxylated neopentyl glycol diacrylate, polyethylene glycol diacrylates with different glycol length, such as diethylene glycol diacrylate, polyethylene glycol 200 diacrylate, polyethylene glycol 400 diacrylate; polyethylene glycol dimethacrylates, such as ethylene glycol dimethacrylate, diethylene glycol dimethacrylate, polyethylene glycol 200 dimethacrylate, polyethylene glycol 600 dimethacrylate; 1,3-butanediol dimethacrylate, 1,4-butanediol diacrylate, 1,4-butanediol dimethacrylate; tri(meth)acrylates, tetra(meth)acrylates, triacrylates and tetraacrylates, such as glyceryl proxy triacrylate, pentaerythritol tetraacrylate, tetraethylene gycol dimethacrylate and multacryl-or multimethacryl-POSS. POSS refers to the polyhedraloligosilsesquioxane commercially available from Hybrid Plastics, Inc. Preferably the crosslinking agent is a difunctional monomer and most preferably it is tetraethylene glycol dimethacrylate (TEGDMA).

The crosslinking agent can generally be used as received, but it is preferred that it too be purified by either distillation or absorptive column chromatography for removing any inhibitor present.

The crosslinking is necessary to yield complete shape memory. Incomplete shape memory (in the range 50-90%) can be obtained without crosslinking, increasingly so for molecular weights greater than 100 kg/mol, but especially greater than 250 kg/mol.

The amount of crosslinking agent is very broad, ranging from 0.3% up to 10% by weight, the exact value dictating the mechanical energy stored during formation of the temporary shape.

As thermal initiators there may be used such initiators as will dissolve into the monomers, including for example tert-amyl peroxybenzoate, 1,1′-azobis(cyclohexanecarbonitrile), benzoyl peroxide, lauroyl peroxide, 4,4-azobis(4-cyanovaleric acid), tert-butylperoxy isopropyl carbonate, and potassium persulfate and preferably 2,2′-azo-bis butyronitrile.

Preferably the initiators are purified by recrystallization using methods known in the art prior to use.

Generally speaking, the monomers can be used over a broad range of amounts and will provide shape memory polymers having attractive shape memory properties, covering a broad ranges of transition temperatures to be selected based on their intended application.

Preferred ranges for medical device applications, where a range of transition temperatures should bracket T=37° C., are: butyl methacrylate (BMA) from 60 to 80%, methyl methacrylate (MMA) from 20 to 40%. These ranges give sharp glass transitions between 30 and 60° C., independent of the crosslinker used for percentages less than 10%.

The amount of initiator to be used will be between 0.1 to 2%, preferred from 0.2% to 1%. If no crosslinker is used, the preferred range is 0.05% to 0.25% to yield high molecular weight polymers.

In accordance with the invention, the transition temperature (T_{g}) is adjusted by the ratio of the monomers, while the degree of crosslinking controls the rubbery modulus plateau. The latter, in turn, dictates the energy stored during a given deformation and thus the energy that is available to release when the polymers recover. The new polymers exhibit very good shape memory effect. The transition temperature can be adjusted as broad as from 20-110° C. The shape memory polymers of the invention can be processed as castable formulations in the form of coatings and films. Further they are optically transparent and colorless. The castable shape memory polymers have great potential to be used, for example as coatings in the processing of novel medical devices.

### DESCRIPTION OF THE DRAWINGS

FIG. 1 is a graph showing the dependence of the thermal stability on MMA content in the copolymers;

FIG. 2 is a diagram of DSC traces for copolymers with MMA weight percentage indicated;

FIG. 3 is a graph showing dependence of T_{g} on copolymer composition expressed as T_{g}⁻¹ vs MMA weight fraction;

FIG. 4 is a graph showing the temperature dependence of tensile storage modulus with and without crosslinking for an MMA and TEGDMA wt fractions of 30 and 5 respectively; and

FIG. 5 is an illustration of strain recovery of cross-linked MMA/BMA/TEGDMA (28.5/66.5/5 wt %) upon rapid exposure to water at T=80° C.

### DESCRIPTION OF EMBODIMENTS OF THE INVENTION

Materials and Synthesis

Alkylmethacrylate monomers (methyl methacrylate, MMA; and butyl methacrylate, BMA) and the cross-linking agent (tetraethylene glycol dimethacrylate, TEGDMA) were purchased from Aldrich. Any inhibitors present in the starting monomers were removed by passing the liquid monomers through an inhibitor removal column purchased from Scientific Polymer Products, Inc. AIBN, purchased from Aldrich was used as received as the thermal initiator. The purified monomers and the cross-linking agent were mixed in varying proportions (here referred to as %A) with AIBN set out in Table 1 (infra) at room temperature by stirring. The mixture was then pre-polymerized in a flask using an oil bath at 65° C. for up to 30 minutes in order to increase the viscosity to a value amenable to casting using the conditions as just set forth, a viscosity similar to that of glycerol is obtained. The viscous fluid was then filled between two casting glass plates with a designed spacer or O-ring inserted for sealing and the assembly then placed into an oven and kept at 40° C. to 60° C., preferably 50° C. for 8 to 50 hours preferably 48 hours. The temperature was then raised to from about 70° C. to about 100° C., for from 10 to 40 hours preferably 20-30 hours and most preferably 80° C. for 24 hours . The temperature was then increased to 90 to 150° C. preferably 100 to 120° C. and maintained at the selected temperature for from 5 to 20 hours and most preferably the temperature was raised to 100° C. for 6 hours so that the residual monomer reacted thoroughly. The samples were then cooled down to room temperature and demolded. The prolonged curing time minimized shrinkage and led to samples free of residual stress, voids, or cracks.

The polymers of the invention can be prepared by the following steps in the sequence indicated. The process is illustrated with specific monomers, cross-linking agent and initiator but applies equally to the other materials disclosed as suitable for use herein.
1. Mix the MMA/BMA/TEGDMA and AIBN (initiator, 0.3% of monomers);
2. Pre-polymerize the liquid mixture at a temperature of about 65° C. for 30 minutes (to increase the viscosity). The pre-polymerization time, can be varied from 0 to 30 minutes, depending on the time required to provide the desired viscosity for casting. For example a viscosity similar to that of glycerol can be obtained using the specific conditions noted.
3. Inject the reactant mixture between two glass slides sealed by O-ring (or any mold prepared to prevent bonding) and place the mold into an oven at 50° C. for 2 days; the range can be from 40° C. to 60° C. but is preferably 50° C. The period can be from 8 hours to 80 hours and is preferably 48 hours for complete reaction.
4. Increase the reaction temperature to 80° C. for 1 day. The range can be from 70 to 100° C., time can be from 10 hours to 40 hours and is preferably 20 to 30 hours.
5. Increase the reaction temperature to 100-120° C. for 10 hours. The range can be from 90 to 150° C. and the time can be from 5 to 20 hours.
6. Cool to room temperature and demold.

The first stage of the process for increasing the viscosity of the reaction mixture may be conducted at room temperature using UV illumination. If this is done, AIBN is the preferred initiator since it can serve as both a UV initiator and thermal initiator, the latter being required for the subsequent cure completion. The UV initiators that may be used include but are not limited to the initiators that are sensitive to UV light undergoing decomposition to free radicals when exposed to UV radiation and include acetophenone, anisoin, anthraquinone, anthraquinone-2-sulfonic acid, sodium salt monohydrate, (benzene) tricarbonylchromium, benzil, benzoin ethyl ether, benzoin isobutyl ether, benzophenone, benzophenone/1-hydroxycyclohexyl phenyl ketone (50/50 blend), 3,3′,4,4′-benzophenonetetracarboxylic dianhydride, 4-benzoylbiphenyl, 2-benzyl-2-(dimethylamino)-4′-morpholinobutyrophenone, 4,4′-bis(diethylamino)benzophenone, 4,4′-bis(dimethylamino)benzophenone, camphorquinone, 2-chlorothioxanthen-9-one, (cumene)cyclopentadienyliron(II) hexafluorophosphate, dibenzosuberenone, 2,2-diethoxyacetophenone, 4,4′-dihydroxybenzophenone, 2,2-dimethoxy-2-phenylacetophenone, 4-(dimethylamino)benzophenone, 4,4′-dimethylbenzil, 4,4′-dimethylbenzil.

If UV illumination is used the following two-step procedure may be carried out.
1. Expose the mixture prepared as above set out and contained within a UV transparent mold to UV irradiation (wavelength 365 mn) of intensity in the range 10-100 mW/cm², preferably 25 mW/cm², at a temperature of from 25° C. to 50° C. (preferably 40° C.) for 60 to 120 hours, preferably 90 minutes.
2. Complete cure by heating to a temperature of 100° C. and maintaining for 10 to 30 hours, for polymerizing the residual monomers and small molecules present.

The following examples are provided to more particularly describe the present invention but are not to be construed as limiting.

### EXAMPLE 1

### Synthesis of the POSS-Containing Castable Shape Memory Polymers

Materials: methacrylisobutyl-POSS (MA0702®, Hybrid Plastics, Inc.) was used as received; methyl methacrylate, butyl methacrylate, tetraethylene glycol dimethylacrylate, and AIBN were purchased from Aldrich and purified as aforementioned.

Polymerization procedures: The materials MA0702, MMA, BMA, TEGDMA, and AIBN were first mixed in a small vial to obtain a clear miscible solution. The clear (solvent-free) solution was then preheated to a temperature of 65° C. for 30 minutes to yield a clear viscous liquid. The liquid was cooled down to room temperature and injected between two glass slides provided with a seal and spacers. This step was facilitated by the 65° C./30 minute preheat which yielded a manageable viscosity. The sealed system was then transferred to an oven preheated to a temperature of 40° C. which was maintained for 48 hours, then increased to 65˜80° C. for ‘another 24 hours, and finally increased to 120° C. for 10 hours so that all of the residual monomers reacted.

The POSS monomer can be added to the formulation as above described up to solubility limit of approximately 15 wt-%. Using MMA ratios ranges from 0% to 30% the moldings show excellent shape memory properties.

### EXAMPLE 2

### Combined UV-Thermal Polymerization

Materials are the same as aforementioned and were used in the amounts which follow: 30% MMA, 70% BMA, 5% TEGDMA based on the total amount of monomers, and 0.3% AIBN as initiator.

The materials were first mixed to make a homogenous clear solution and then injected between two glass slides, one glass slide preferably being quartz, and heated to 40° C.; a UV lamp with a wavelength of 365 nm was used to illuminate the reactive mixture for 90 minutes until it solidified. The preparation was moved to an oven maintained at 100 to 120° C. for 24 hrs to have all the residual monomers polymerized.

The resultant molding showed similar thermomechanical properties as compared to thermally cured moldings, but with an advantage of demolding after partial solidification, thermomechanical forming to a complex 3D shape, and cure completion.

The process was repeated but without UV illumination at 40° C. for 24 hrs and the mixture still kept a liquid form indicating that UV illumination plays a leading role in the solidification of the UV-thermally polymerized sample.

Thermal Characterization

The thermogravimetric analysis (TGA) and differential scanning calorimetry (DSC) were carried out using Perkin-Elmer instruments (models 951 and 2910, respectively). For the TGA analysis, the samples were heated in a nitrogen atmosphere from room temperature to 600° C. at a rate of 20° C./minute. The onset temperature of weight loss and the percentage of weight loss were recorded. For DSC, the samples were first heated from −50° C. to 150° C. at a rate of 10° C./minute to erase all of the prior thermal history; the samples were then quenched to −50° C. at a rate of 80° C./minute and the samples finally reheated to 150° C. at a rate of 10° C./minute. The temperature corresponding to the midpoint in heat capacity for such second heating runs was used to determine the glass transition temperature of the polymers.

Dynamic Mechanical Analysis

The moduli of the SMPs were measured by dynamic mechanical thermal analysis (DMTA) in tensile mode using the TA Instruments DMA 2980. The method adopted was temperature-ramp at fixed mechanical oscillation frequency of 1 Hz. The temperature was ramped from −100° C. to 200° C. at the heat rate of 4° C./minute. A rectangular film shape was chosen and the geometry of the film was length×width×thickness of 15×2×1.2 mm, respectively.

Shape Memory

Stress-free shape recovery procedures were carried out in order to assess the ability of the prepared samples to recover strain induced in the rubbery state and frozen into the glassy state. The samples were first cut to a rectangular shape and stained to a red color to impart optical contrast. A particular sample was then bent into a circular shape about the width axis to an inner diameter of 0.737 cm while heating in a warm water bath having a T=90° C. The deformed sample was then quenched in ice water to fix the form through vitrification. The resulting bent sample was subsequently dipped into a warm water bath at a prescribed temperature using a customized plunger and the shape recovery monitored visually using a video camera and digital frame-grabber collecting images at a rate of 20 frames-per-second.

TGA of the SMPs Having Different Monomers Ratio

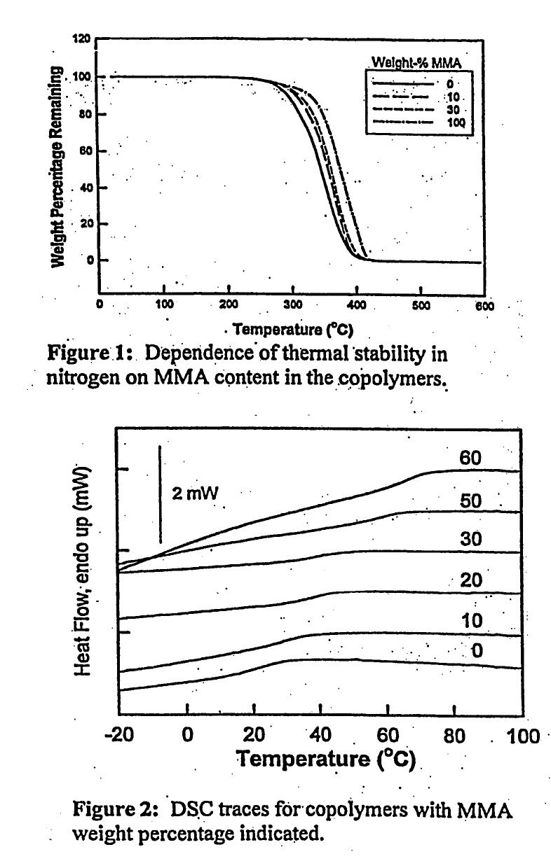

A series of shape memory polymers having different ratios of MMA to BMA (from 0% to 100%) were synthesized and characterized using the procedures which have been described above and the thermal stability of the polymers measured by TGA as shown in FIG. 1. It can be seen that that with pure polymer of BMA (0% of MMA), the film is quite stable and does not decompose below 250° C. When the MMA is incorporated in the copolymers, the decomposition temperatures of the copolymers shift to higher temperatures. Further increasing the monomer MMA increases the decomposition temperature with the homopolymer of PMMA having the highest decomposition temperature, which is about 50° C. above homopolymer PBMA. This establishes that MMA monomer contributes stability more than BMA and that all of the polymers are sufficiently stable for use in connection with a medical device. All of the polymers can be totally decomposed in nitrogen when heated above 450° C.

DSC of SMP Having Different Monomer Ratios

The glass transition temperatures of the SMPs having different ratios of the monomer MMA, from 0% to 100% were measured by DSC and the results are shown in FIG. 2 and summarized in Table 1.

TABLE 1
the T_{g} of the copolymers having different monomer ratios

| | | | | |
|---|---|---|---|---|
| Monomer ratio | 0 | 0.1 | 0.2 | 0.3 |
| (MMA/MMA + | | | | |
| BMA | | | | |
| T_{g} (° C.) | 22.1 | 27.2 | 38.3 | 44.2 |
| Monomer ratio | 0.4 | 0.5 | 0.6 | 1.0 |
| (MMA/MMA + | | | | |
| BMA) | | | | |
| T_{g} (° C.) | 50.7 | 59.0 | 65.6 | 117.7 |

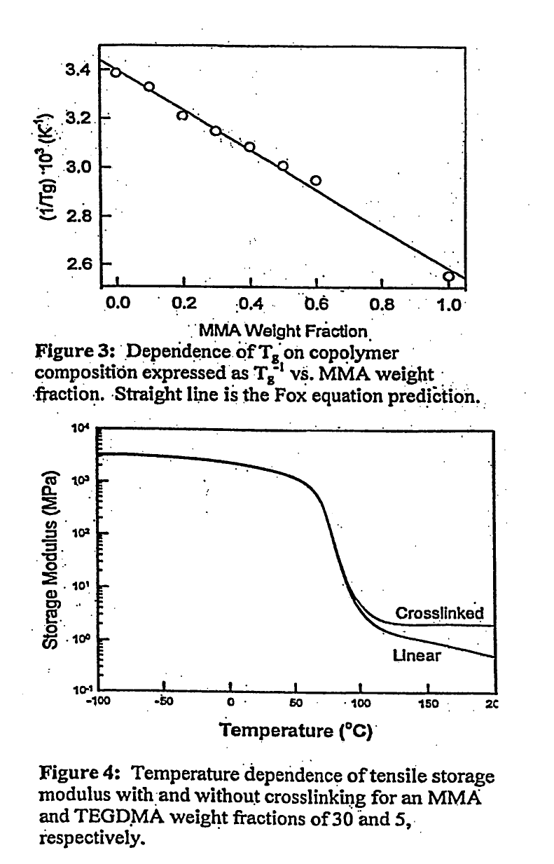

From FIG. 2 it can be seen that the copolymers form only one T_{g}, which indicates that the copolymers are reasonably random in the distribution of monomers along the backbone. While pure poly(butyl methacrylate) evidences a measured T_{g} of 22.2° C., addition of MMA leads to a systematic increase in the glass transition temperature to higher temperatures. Ultimately, pure PMMA prepared by the method of the invention evidences a T_{g} of 117.7° C. Thus the transition temperature for shape memory behavior can be easily tailored through composition variation of the two monomers. The T_{g}'s of the polymers are listed in Table 1 and correlated by the Fox equation (FIG. 3). The results show that the equation corresponds with the data.

DMTA Comparison of CSMPs with and without Cross-Linking

The temperature-dependent storage modulus of a polymer with cross-linking was compared with that of polymer without cross-linking at the same monomer ratio using DMTA (FIG. 4). The particular samples compared in this figure have MMA/BMA/TEGDMA weight fractions of 30/70/0 and 28.5/66.5/5 for the uncrosslinked and crosslinked samples, respectively. Both polymers show glassy mechanical response with a tensile modulus ˜3 10⁹ Pa for temperatures below 70° C. When the temperature reaches 70° C., the modulus begins to drop dramatically and reaches its rubbery state at 100° C. For this system, for low TEGDMA concentrations (this case, 5 wt %) the glass transition temperature is unaffected, thus allowing independent control over T_{g} and rubber modulus. Without the cross-linking agent, the rubbery modulus of the polymer falls rapidly with increasing temperature until viscous flow occurs; no rubber plateau is sustained. With cross-linking, the sample shows a flat modulus plateau and does not flow until thermal degradation. This tunability of thermomechanical properties with MMA and TEGDMA content yields a material system that can be adjusted for providing applications that define the critical temperature and rubber modulus (mechanical work) requirements.

Shape Memory Behavior of the CSMPS

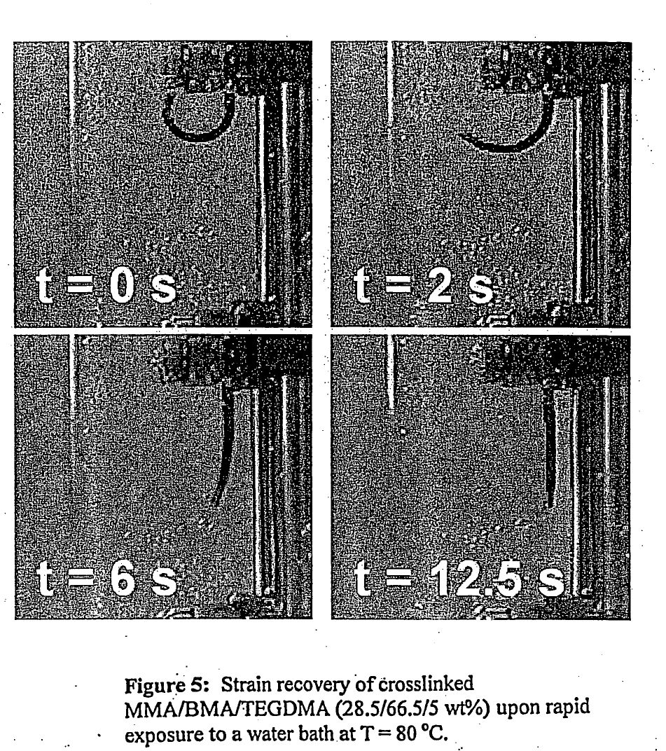

The stress-free strain recovery of a castable shape memory polymer strip was carried out and the results are shown in FIG. 5. The original form of the polymer (permanent form) was a strictly flat rectangular strip. The strip was deformed to a circle (secondary form) and fixed as described in connection with the shape memory procedure. The shape memory of the deformed strip was triggered by heating to above the critical temperature by immersion into a warm water bath at 90° C. quickly. As can be seen in FIG. 5, the speed and the extent of recovery of the strip as recorded digitally, show that the strip has a good shape memory effect and can recover to its original shape totally in 10 seconds. Most of the strain however, is recovered within the first five seconds.

Because of their unique memorizing properties, the castable shape memory materials can be used for example as a passive optical temperature sensor. In such application, the CSMP is cast upon packaging material with a written message (e.g. “this package has exceeded 85° F.”) and then embossed or foamed to render the transparent coating opaque. When the coating is heated up beyond a prescribed temperature (the CSMP critical temperature), it will become optically clear again via shape memory to allow display of the package message. Use of a series of CSMPs with distinct transition temperatures, as described in reference to FIG. 2, can enable different messages to be revealed for different exposure temperatures. Another example of the applications of the CSMPs of the invention are as heat-triggered self-deployable, single-use pumps. By rotational molding of the CSMP in a heated mold, a hollow tank can be processed by thermal curing and subsequently expanded with gas pressure above the CSMP T_{g}, cooled to room temperature, and filled with a liquid. Specifically, any liquid that will not swell the CSMP material, such as an aqueous solution, water-based paint, can be used. On heating the tank to above the CSMP T_{g}, the liquid can be readily expelled to completion at a pressure dictated by the polymer's rubber modulus and by the flow restriction (nozzle) employed. Reuse of this pump could be achieved by pressurization with a gas above the CSMP critical temperature. This latter application is useful for miniature rocket motors, one-time disposable paint-sprayers, and for thermally-triggered release of chemicals.

The shape memory polymers of the invention have a tremendous number of other applications, as objects and as castable formulations in the form of coatings, films and adhesives. The shape memory polymers are particularly useful in medical and biological applications, for example, as sutures, orthodontic materials, bone screws, nails, plates, meshes, prosthetics, pumps, catheters, films, stents, scaffolds for tissue engineering, drug delivery devices, thermal indicators and the like.

Because of their unique memorizing properties, shape memory materials are used increasingly in the medical device industry for self-triggering stents, catheters and auxiliary devices. The devices can be thermomechanically trained and surgically manipulated within the body, then treated with heat or other ways during the operations to trigger the transitions for the device to perform certain mechanical actuation in the body. The SMP materials have a great potential for modifying existing medical devices because both the transition temperature (T_{g}) and the recovery force (rubber modulus) according to the surgical requirements can be predetermined. Moreover, the extent of deformation can be as large as 200%. The known SMA devices can only deform as much as 8% and the critical temperatures are hard to adjust. Further, the shape memory materials' of the invention optical transparency as well as their ability to accept dyes considerably enhance and broaden their applications.

An additional embodiment of this invention involves the dissolution of a polymer such as polymethylacrylate in the reactive mixture to accomplish viscosity enhancement otherwise achieved in the present invention by precuring. All polymers soluble in the monomer mixtures as set forth herein and which yield miscible solutions during ploymerization are good candidates for such a polymer. Examples include but are not limited to: poly(alkyl methacrylates), poly(alkyl acrylates), copolymers of poly(akyl methacrylates) and poly(akyl acrylates), POSS modified poly(alkyl(meth)acrylates) that will dissolve into the reactant mixture. In a preferred embodiment poly(butyl methacrylate) and copolymer of MMA and POSS-acrylate (MA0702) have been used to dissolve in a reactive mixture of BMA/MMA/TEGDMA/AIBN, achieving an advantageous increase in viscosity. The concentration of the polymer can range from 0% up to the miscibility limits, preferably 10 to 40 wt-%. Shape memory behavior is not compromised by this additional component when used as above described.

Various other embodiments or other modifications of the disclosed embodiments will be apparent to those skilled in the art upon reference to this description, or may be made without departing from the spirit and scope of the invention defined in the appended claims.

What is claimed is:

1. A shape memory polymer composition obtained by copolymerizing two different monomers, the homopolymers of which would each have a different glass transition temperature to produce a copolymer having a glass transition temperature between that of the two homopolymers.

2. Shape memory polymer according to claim 1 wherein said monomer are each a member selected from the group consisting of vinyl monomers, vinylidene monomers and alkyl methacrylates.

3. A shape memory polymer composition according to claim 2 wherein said monomers are each vinyl monomers.

4. A shape memory polymer composition according to claim 1 wherein one of said monomers is a high T_{g} polymer forming monomer and is a member selected from the group consisting of vinyl chloride, vinyl butyral, vinyl fluoride, vinyl pivalate, 2-vinyl chloride, vinyl butyral, vinyl fluoride, vinyl pivalate, 2-vinylnaphthalene, 2-vinylpyridine, 4-vinyl pyridine, vinylpyrrolidone, n-vinyl carbazole, vinyl toluene, vinyl benzene(styrene), methyl methacrylate, ethyl methacrylate, acryl-functionalized POSS, and methacryl-functionalized POSS.

5. A shape memory polymer composition according to claim 1 wherein one of said monomers is a low T_{g} polymer-forming monomer and is a member selected from the group consisting of vinyl ethyl ether, vinyl laurate, vinyl methyl ether, vinyl propionate, alkyl acrylates, and alkyl methacrylates.

6. A shape memory polymer composition according to claim 1 wherein one of said monomers has a high glass transition temperature and is selected from the group consisting of vinyl chloride, vinyl butyral, vinyl fluoride, vinyl pivalate, 2-vinylnaphthalene, 2-vinylpyridine, 4-vinyl pyridine, vinylpyrrolidone, n-vinyl carbazole, vinyl toluene, vinyl benzene(styrene), methyl methacrylate, ethyl methacrylate, acryl-functionalized POSS, and methacryl-functionalized POSS and said other monomer has a low glass transition temperature and is selected from the group consisting of vinyl ethyl ether, vinyl laurate, vinyl methyl ether, vinyl propionate, alkyl acrylates and alkyl methacrylates.

7. A shape memory polymer composition according to claim 1 wherein said high glass transition temperature monomer is methyl methacrylate and said low glass transition monomer is butyl methacrylate.

8. A shape memory polymer composition according to claim 1 wherein the glass transition temperature of the copolymer is adjustable to from 20-110° C.

9. A shape memory polymer composition according to claim 1 wherein a multifunctional monomer is incorporated into the copolymerization reaction whereby the copolymer is crosslinked during the polymerization to form a thermoset network.

10. A shape memory polymer composition according to claim 9 wherein said multifunctional monomer is a disfunctional monomer.

11. A shape memory polymer composition according to claim 10 wherein the difunctional monomer is an alkyl dimethacrylate.

12. A shape memory polymer composition according to claim 10 wherein said multifunctional monomer is selected from the group consisting of ethylene glycol dimethacrylate, diethylene glycol dimethacrylate, polyethylene glycol 200 dimethacrylate, polyethylene glycol 600 dimethacrylate; propoxylated neopentyl glycol diacrylate, 1,3-butanediol dimethacrylate, 1,4-butanediol diacrylate, 1,4-butanediol dimethacrylate, glyceryl proxy triacrylate, pentaerythritol tetraacrylate, tetraethylene gycols dimethacrylate and multacryl and multimethacryl-POSS.

13. A shape memory polymer composition according to claim 7 wherein the ratio of methylmethacrylate to butylmethacrylate is from 20-80:80-20% methylmethacrylate to butylmethacrylate.

14. A shape memory polymer composition according to claim 7 wherein an increase in the methylmethacrylate content in the copolymer results in an increase in the glass transition temperature of the copolymer.

15. A shape memory polymer composition obtained by copolymerizing two different monomers, the homopolymers of each of which would have a different glass transition temperature in the presence of a difunctional monomer so that the resulting copolymer is crosslinked and has a glass transition temperature between that of said homopolymers.

16. A shape memory polymer composition according to claim 15 wherein the glass transition temperature of one of the homopolymers is about 20° C., and that of the other homopolymers is about 120° C.

17. A shape memory polymer composition according to claim 15 wherein the difunctional monomer is tetraethylene diglycol dimethacrylate.

18. A shape memory polymer composition according to claim 17 wherein the tetraethylene glycol dimethacrylate content defines the rubber modulus of the polymer and is present in an amount of up to 20%.

19. A shape memory polymer composition according to claim 18 wherein said tetraethylene glycol dimethacrylate is present in an amount of from 0.5 to 10%.

20. A method of forming a composition with a shape in memory comprising the steps of:
a) preparing a copolymer comprising two different monomers, the homopolymers of each of which would have different glass transition temperatures, in the presence of a difunctional monomer to provide a copolymer which is crosslinked and which has a glass transition temperature between that of the two homopolymers;
b) shaping the composition to a first shape while heating to form a deformed sample;
c) quenching the deformed sample in cold water,
d) heating the quenched sample in warm water whereby the deformed sample is returned to its original shape.

21. The method according to claim 20 wherein step a) is conducted using UV illumination.

22. A medical device or component of a medical device comprising the shape memory polymer composition of claim 1.

23. A medical device or component of a medical device according to claim 22 which is a member selected from the group consisting of stents, catheters, prosthetics, grafts, screws, pins, plates, pumps and meshes.

24. An optically transparent shape memory polymer composition obtained by copolymerizing two different monomers, the homopolymers of which each would have a different glass transition temperature to produce a copolymer having a glass transition temperature between that of the two homopolymers.

25. An optically transparent shape memory polymer composition according to claim 24 wherein the copolymer is dyeable.

26. An optically transparent shape memory polymer composition according to claim 24 wherein the copolymer is colorless.

27. An optically transparent shape memory polymer composition according to claim 24 which can be cast, extruded or molded.

28. An optically transparent shape memory polymer composition according to claim 24 for use as an optical shutter for thermal sensing.

29. An optically transparent shape memory polymer composition according to claim 24 for use in reversible embossing for information storage or for microfluidic devices.

30. An optically transparent shape memory polymer composition according to claim 24 for use in deployable structures with complex shape tents.

31. An optically transparent shape memory polymer composition according to claim 24 for use in eyeglasses.

32. An adhesive comprising a shape memory polymer composition according to claim 6.

33. A shape memory polymer composition according to claim 6 in the form of a film.

34. A shape memory polymer composition according to claim 6 in the form of a coating.

35. A shape memory polymer composition according to claim 6 in the form of a solid casting.
